(19) United States
(12) Patent Application Publication
(10) Pub. No.: US 2007/0157235 A1
(43) Pub. Date: Jul. 5, 2007

(54) Method and apparatus for reverting to a preferred program at the end of a commercial interruption

(75) Inventor: Harold W. A. Teunissen, Deventer (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies Inc.

(21) Appl. No.: 11/324,926

(22) Filed: Jan. 4, 2006

(51) Int. Cl. H04N 7/16; H04N 5/445; H04N 5/50; G06F 13/00

(52) U.S. Cl. 725/38; 725/135; 348/731; 725/37

(57) ABSTRACT

The invention includes a method and apparatus for switching between programming streams in response to a programming change event. A first method may include receiving a first programming stream and a second programming stream, selecting the first programming stream for displaying first programming conveyed by the first programming steam, monitoring the second programming stream while displaying the first programming, and, in response to a detecting a first programming change event in the second programming stream, initiating a channel change action adapted for selecting the second programming stream for displaying second programming conveyed by the second programming steam. A second method may include detecting a programming change event on a channel conveying a programming stream including a preferred program and initiating a channel change action adapted for selecting the channel conveying the programming stream including the preferred program for displaying the preferred program.

### FIELD OF THE INVENTION

The invention relates to the field of television systems and, more specifically, to monitoring and selecting television programming.

### BACKGROUND OF THE INVENTION

In general, a television viewer will often switch television channels, from an original channel carrying an original program to one or more other channels carrying various other programs, when the original program is interrupted by a commercial break. Although the television viewer may intend to return to the original channel just prior to resumption of the original program, for various reasons, the television viewer may return to the original channel after the resumption of the original program. For example, the television viewer may overestimate the amount of time until the original program resumes on the original channel, or may forget to switch back to the original channel after becoming interested in one of the other programs on the other channels. As such, television viewers often return to the original channel after the original program has already resumed, thereby causing the television viewer to miss at least a portion of the original program.

### SUMMARY OF THE INVENTION

Various deficiencies in the prior art are addressed through the invention of a method and apparatus for switching between programming streams in response to a programming change event. A first method may include receiving a first programming stream and a second programming stream, selecting the first programming stream for displaying first programming conveyed by the first programming steam, monitoring the second programming stream while displaying the first programming, and, in response to a detecting a first programming change event in the second programming stream, initiating a channel change action adapted for selecting the second programming stream for displaying second programming conveyed by the second programming steam. A second method may include detecting a programming change event on a channel conveying a programming stream including a preferred program and initiating a channel change action adapted for selecting the channel conveying the programming stream including the preferred program for displaying the preferred program.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a television distribution network;

FIG. 2 depicts a high-level block diagram of one of the customer premise equipment of FIG. 1;

FIG. 3 depicts a method according to one embodiment of the present invention; and

FIG. 4 depicts a method according to one embodiment of the present invention.

To facilitate understanding, identical reference numerals have been used, where possible, to designate identical elements that are common to the figures.

### DETAILED DESCRIPTION OF THE INVENTION

The present invention enables initiation of a channel change action adapted for reverting from the second television channel to the first television channel in response to detecting that a preferred television program delivered by the first television channel has resumed (e.g., reverting from Discovery channel to ABC channel in response to detecting that a television program on ABC channel has resumed following a program interruption). The channel change action may include automatic reversion from the second television channel to the first television channel, generation of a notification providing an option for manual reversion from the second television channel to the first television channel, and the like.

The present invention receives a first programming stream conveying television content associated with a first television channel and a second programming stream conveying television content associated with a second channel. The first programming stream is initially selected for displaying television content (e.g., a preferred program) associated with the first television channel. Upon detection of a programming change event (e.g., start of a programming interruption event such as a commercial, public service announcement, and the like), the second programming stream (comprising one of a plurality of available programming streams) is selected (automatically or manually) for displaying television content associated with the second programming stream. The present invention monitors the first television programming stream while the second television programming stream is selected for displaying television content conveyed by the second programming stream.

In one embodiment, the present invention automatically switches television channels in response to a programming change event. The television channel switch includes a change from selecting the first television programming stream to selecting the second television programming stream. In other words, the present invention enables automatic reversion, e.g., at the end of a commercial interruption, to a television channel conveying a preferred program, e.g., when the user has switched to another television channel during a commercial interruption on the television channel carrying the preferred program.

In one embodiment, the present invention generates a programming notification in response to a programming change event (e.g., the end of a commercial interruption of a preferred program, the resumption of a preferred program following a commercial interruption, and the like). The programming notification informs a user of the programming change event. In one embodiment, the programming notification provides the user a means of switching to the television channel conveying the preferred program.

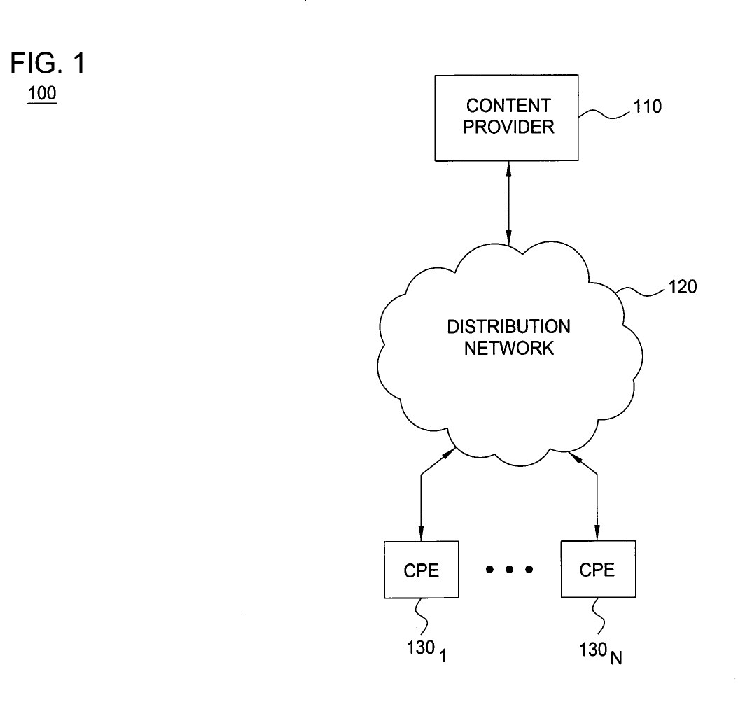

FIG. 1 depicts a high-level block diagram of a television distribution network. Specifically, television distribution network 100 of FIG. 1 comprises a content provider (CP) 110, a distribution network (DN) 120, and a plurality of customer premise equipment (CPEs) 130₁-130_{N} (collectively, CPEs 130). As depicted in FIG. 1, CP 110 is a television service provider providing television content (e.g., television programs, commercials, public service announcements, and the like). The television content is conveyed from CP 110 to CPEs 130 using a plurality of programming streams, where each programming stream includes a data stream associated with a television channel. The programming streams are transported using DN 120.

As depicted in FIG. 1, DN 120 is a communication network operable for distributing information from content providers (illustratively, content provider 110) to a plurality of customer locations (illustratively, CPEs 130). In one embodiment, the distributed information comprises television content (e.g., television programs, supplemental television information, commercials, and the like). In one embodiment, the distributed information further comprises information associated with other services (e.g., high-speed data communications, voice telephony, interactive video, and like services). In one embodiment, DN 120 is a communication network operable for transporting information from a plurality of customer locations to content providers. In one such embodiment, the information includes television control information adapted for controlling distribution of the television content. In another such embodiment, the information includes high-speed data communications information, voice telephone, and like information).

As depicted in FIG. 1, DN 110 may include various combinations of networks and associated network elements. In one embodiment, DN 110 includes a core transport network portion and a plurality of local loop network portions, where the core transport network portion is operable for transporting information between content providers and each of the local loop network portions, and the local loop network portions transport information between the core transport network portion and customer premise equipment. In one embodiment, the core transport network portion of DN 110 may include at least one of an optical transport network (OTN), an Internet Protocol (IP) network, and the like, as well as various combinations thereof. In one embodiment, the local loop network portion of DN 110 may include at least one of a hybrid fiber coaxial (HFC) network including host digital terminals (HDTs), head-end modems (HEMs), and the like, an Integrate Digital Loop Carrier (IDLC) network, a Fiber To The Neighborhood (FTTN), a Fiber To The Curb (FTTC), Fiber To The Home (FTTH), and the like.

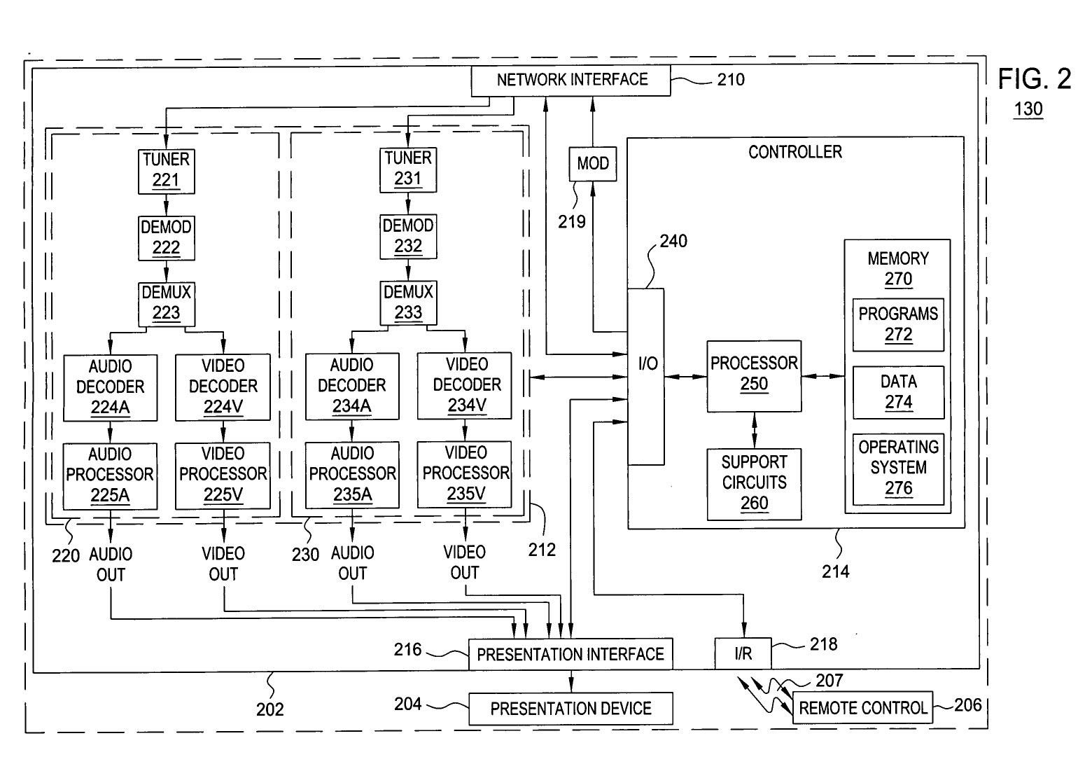

As depicted in FIG. 2, CPEs 130 include equipment adapted for receiving television programming streams from CP 110 via DN 120 and processing received television programming streams for displaying associated television programming (e.g., television programs, commercials, public service announcements, and the like) conveyed by television programming streams. For example, CPEs 130 may include analog television equipment, digital television equipment, and various combinations thereof. A customer premise equipment in accordance with one embodiment of the present invention is depicted and described herein with respect to FIG. 2. As depicted and described with respect to FIG. 2, a customer premise equipment includes a set top terminal, a presentation device, and a remote control.

In one embodiment, the present invention is implemented as a program product for use with a computer system such as, for example, the set top terminal processing system 200 and described below. The program(s) of the program product defines functions of the invention embodiments and may be included on various media. For example, such media may include information permanently stored on non-writable storage media (e.g., read-only memory devices within a computer such as CD-ROM disks readable by a CD-ROM drive); alterable information stored on writable storage media (e.g., floppy disks within a diskette drive or hard-disk drive); information conveyed to a computer by a communications medium (e.g., through a computer or telephone network). Furthermore, such media, when carrying computer-readable instructions that direct various functions of the present invention, represent associated embodiments of the present invention.

In general, the routines and methods executed to implement embodiments of the present invention, whether implemented as part of an operating system or a specific application, applet, component, program, module, object, or sequence of instructions may be referred to herein as a “program”. The program may be comprised of instructions translatable by a native computer into a machine-readable format (i.e., executable instructions), and may include variables, data structures, and the like. Furthermore, various programs described hereinafter may be identified based upon the application for which the programs are implemented. Moreover, it should be appreciated that any particular program nomenclature that follows is used merely for convenience, and thus the invention should not be limited to use solely in any specific application identified or implied by such nomenclature.

FIG. 2 depicts a high-level block diagram of one of the customer premise equipment of FIG. 1. Specifically, CPE 130 of FIG. 2 includes a set top terminal (STT) 202, a presentation device (PD) 204, and a remote control (RC) 206. The STT 202 receives television programming streams from CP 110. The STT 202 processes television programming streams for displaying (using PD 204) television content conveyed by the television programming streams. The PD 204 presents television content (i.e., audio content, video content, overlay information, and the like) provided by the television programming stream. The RC 206 communicates with STT 202 for enabling user interaction with STT 202 (e.g., channel change operations, program guide selection operations, and the like).

As depicted in FIG. 2, STT 202 includes a network interface (NI) 210, a programming stream processor module (PSPM) 212, a controller (CNT) 214, a presentation interface (PI) 216, an infrared receiver (IRR) 218, and a modulator (MOD) 219. The PSPM 212 includes a first tuner module (FTM) 220 and a second tuner module (STM) 230. As depicted in FIG. 2, NI 210 receives programming streams from CP 110 and provides the programming streams to FTM 220 and STM 230 of PSPM 212. The FTM 220 and STM 230 process the programming streams for providing audio output and video output signals to PI 216. The CNT 214 communicates with NI 210, PSPM 212, and PI 216 for controlling various programming stream selection, monitoring, and processing functions in accordance with various embodiments of the present invention.

As depicted in FIG. 2, RC 206 includes a remote control unit providing one or more users a means for performing various user initiated actions (e.g., channel change operations, program guide selection operations, and the like). Although not depicted, RC 206 may include one or more joysticks, numeric pads, channel change buttons, volume change buttons, various other buttons (e.g., “guide”, “select”, and the like), and the like, as well as various combinations thereof. The user selections (by manipulation of the various joysticks, buttons, and the like of RC 206) are transmitted to IRR 218 of STT 202 using an infrared signal (IRS) 207.

As depicted in FIG. 2, IRR 218 propagates the user selections to CNT 214. The CNT 214 communicates with IRR 218 for processing user-initiated commands received from RC 206 over IRS 207. The CNT 270 is responsive to such user selections and executes appropriate user interaction routines. The CNT 270 optionally propagates user-initiated command information, controller information, and like information to various network components (not depicted; e.g., a head end modem (HEM)) of DN 120. The MOD 219 modulates the user-initiated command information, controller information, and like information. The MOD provides the modulated information to NI 210 for transmission towards DN 120.

As depicted in FIG. 2, PSPM 212 includes FTM 220 and STM 230. In one embodiment, in which television content is conveyed using analog programming signals, FTM 220 and STM 230 may be implemented as programming signal modulators. In one embodiment, in which television content is conveyed using digital programming signals, FTM 220 and STM 230 may be implemented as digital programming signal processors. In one embodiment, one of FTM 220 and STM 230 is selected by CNT 230 for displaying television content conveyed by a programming stream associated with the selected one of FT 222 and ST 224.

As depicted in FIG. 2, FTM 220 includes a tuner 221, a demodulator 222, a demultiplexer 223, an audio decoder 224A and a video decoder 224V, and an audio processor 225A and a video processor 225V. The tuner 221 receives a programming stream, e.g., a radio frequency signal including a plurality of quadrature amplitude modulated (QAM) information signals from a downstream channel (received by NI 210). In response to various control signals from CNT 214, tuner 221 tunes a particular one of the QAM information signals to produce an intermediate frequency QAM information signal. The demodulator 222 receives and demodulates the intermediate frequency QAM information signal to produce an information stream (e.g., a Motion Picture Experts Group (MPEG) programming stream. The demodulator 222 provides the information stream to demultiplexer 223.

The demultiplexer 223 demultiplexes the information stream for extracting an audio information stream and a video information stream. The demultiplexer 223 provides the audio information stream and video information stream to audio decoder 224A and video decoder 224V, respectively. The audio decoder 224A and video decoder 224V decode the audio stream and video stream, respectively. The audio decoder 224A and video decoder 224V provide the decoded audio stream and decoded video stream to audio processor 225A and video processor 225V, respectively. The audio processor 225A and video processor 225V adapt the decoded audio stream and decoded video stream, respectively, to produce an audio output signal and a video output signal adapted for presentation by PD 204.

As depicted and described with respect to FIG. 2, a first programming stream associated with FTM 220 assumes many forms during processing of received signals for producing audio output and video output signals adapted for presentation using PD 204. As depicted in FIG. 2, FTM 220 is adapted for providing a first programming stream to PI 216 in response to selection of FTM 220 by CNT 214. In one embodiment, selection of FTM 220 for providing the first programming stream to PI 216 prevents concurrent selection of STM 230 for providing a second programming stream to PI 216. In one further embodiment, in response to a programming change event in the first programming stream, manual selection of STM 230 may be performed (e.g., user initiates a channel change operation during a commercial interruption of a preferred program) for providing the second programming stream to PI 216.

In one such embodiment, FTM 220 monitors the first programming stream for detecting the programming change event (e.g., an end of a programming interruption event, a resumption of a preferred program, and the like). The FTM 220 may monitor the first programming stream using at least one of tuner 221, demodulator, 222, demultiplexer 223, audio and video decoders 224A and 224V, and audio and video processors 225A and 225V, and other like components (not depicted), as well as various combinations thereof. Upon detection of the programming change event on the first programming stream, FTM 220 notifies CNT 230 of the programming change event. The CNT 230 initiates an action adapted for switching from selection of STM 230 for providing the second programming stream to PI 216 to selection of FTM 220 for providing the first programming stream to PI 216 (i.e., resumption of the preferred program conveyed by the first programming stream results in processing of the first programming stream by FTM 220 for displaying the preferred program).

As depicted in FIG. 2, STM 230 includes a tuner 231, a demodulator 232, a demultiplexer 233, an audio decoder 234A and a video decoder 234V, and an audio processor 235A and a video processor 235V. The tuner 231, demodulator 232, demultiplexer 233, audio decoder 234A and video decoder 234V, and audio processor 235A and video processor 235V of STM 230 operate in a substantially similar manner to the tuner 221, demodulator 222, demultiplexer 223, audio decoder 224A and video decoder 224V, and audio processor 225A and video processor 225V of FTM 220, respectively. Although depicted and described using identical structures, in one embodiment, FTM 220 and STM 230 may be implemented using different component configurations, different components, and the like, as well as various combinations thereof.

As depicted and described with respect to FIG. 2, a second programming stream associated with STM 230 assumes many forms during processing of received signals for producing audio output and video output signals adapted for presentation using PD 204. As depicted in FIG. 2, STM 230 is adapted for providing a second programming stream to PI 216 in response to selection of STM 230 by CNT 230. In one embodiment, selection of STM 230 for providing the second programming stream to PI 216 prevents concurrent selection of FTM 220 for providing the first programming stream to PI 216. In one further embodiment, in response to a programming change event (e.g., commercial) in the second programming stream, manual selection of FTM 220 may be performed (e.g., user initiates a channel change operation during a commercial interruption of a preferred program) for providing the first programming stream to PI 216.

In one such embodiment, STM 230 monitors the second programming stream for detecting the programming change event (e.g., an end of a programming interruption event, a resumption of a preferred program, and the like). The STM 230 may monitor the second programming stream using at least one of tuner 231, demodulator, 232, demultiplexer 233, audio and video decoders 234A and 234V, and audio and video processors 235A and 235V, and other like components (not depicted), as well as various combinations thereof. Upon detection of the programming change event on the second programming stream, STM 230 notifies CNT 230 of the programming change event. The CNT 230 initiates an action adapted for switching from selection of FTM 220 for providing the first programming stream to PI 216 to selection of STM 230 for providing the second programming stream to PI 216 (i.e., resumption of the preferred program conveyed by the second programming stream results in processing of the second programming stream by STM 230 for displaying the preferred program).

As depicted and described with respect to FIG. 2, FTM 220 and STM 230 are operable for supporting the programming stream including the preferred program. Similarly, as depicted and described with respect to FIG. 2, FTM 220 and STM 230 are operable for supporting the programming stream selected for presentation during interruption of the preferred program by a program interruption event. As described herein, the terms first programming stream (and first channel) and second programming stream (and second channel) is intended to provide clarity and, as such, are not intended to limit the present invention.

In one embodiment, FTM 220 and STM 230 provide respective processed programming streams to PI 216. In one such embodiment, PI 216 selects one of the programming streams from FTM 220 or STM 230 for displaying the associated television content using PD 204. In one such embodiment, selection of one of the programming streams from FTM 220 or STM 230 is performed in response to control signals received from CNT 230. In one such embodiment, the control signals received by CNT 230 are generated by CNT 230 in response to monitoring at least one of the programming streams processed by FTM 220 and STM 230.

As depicted in FIG. 2, CNT 214 includes an input-output module (I/O) 240, a processor (PROC) 250, support circuitry (SC) 260, and a memory (MEM) 270. The I/O 240 forms an interface between CNT 214 and NI 210, PSPM 212, PI 216, IRR 218, and MOD 219. The PROC 250 cooperates with SC 260, such as power supplies, clock circuits, cache memory, and the like, as well as circuits that assist in executing software routines stored in MEM 270. Ad depicted in FIG. 2, MEM 270 includes storage space for storing programs 272, data 274, and an operating system (OS) 276. As described herein, CNT 214 is adapted for performing at least a portion of the functions of the present invention.

In one embodiment, CNT 214 cooperates with NI 210, PSPM 212, PI 216, and like components for performing programming stream selection and monitoring functions in accordance with various embodiments of the present invention. In one embodiment, CNT 214 is adapted for selecting a programming stream associated with one of FTM 220 and STM 230 for displaying television content conveyed by the selected programming stream. In one such embodiment, CNT 214 is adapted for monitoring a programming stream associated with the unselected one of FTM 220 and STM 230 for detecting a programming change event (e.g., the end of a programming interruption event).

In one embodiment, CNT 214 cooperates with NI 210, PSPM 212, PI 216, IRR 218, and like components for performing programming stream reversion functions (i.e., functions associated with performing a channel change action in response to detecting a programming change event). In one embodiment, CNT 214 generates control signals adapted for automatically selecting a monitored programming stream for displaying the monitored programming stream (i.e., selecting the programming stream for which the programming change event is detected). In one further embodiment, CNT 214 generates control signals adapted for deselecting a displayed programming stream (i.e., for switching selecting the programming stream for which the programming change event is detected).

In one embodiment, CNT 214 is configurable for selecting a first programming stream associated with a first module (illustratively, FTM 220) for displaying first programming conveyed by the first programming stream, monitoring a second programming stream associated with a second module (illustratively, STM 230) for detecting a programming change event associated with second programming conveyed by the second programming stream, and, in response to detecting the programming change event, selecting the second programming stream associated with the second module for displaying second programming conveyed by the first programming stream.

In one further embodiment, CNT 214 is further configurable for deselecting, in response to detecting the programming change event, the first programming stream associated with the first module for preventing first programming conveyed by the first programming stream from being displayed. In one further embodiment, CNT 214 is further configurable for monitoring, in response to detecting the programming change event, the first programming stream associated with the first module for detecting a programming change event associated with the first programming conveyed by the first programming stream.

In one embodiment, CNT 214 cooperates with PSPM 212, PI 216, IRR 218, and like components for performing programming change event notification functions (i.e., functions associated with informing a user of a programming change event and providing a user a means of reverting from selecting one programming stream to selecting another programming stream). In one embodiment, CNT 214 produces signals adapted for generating a programming change event notification. In one embodiment, the programming change event notification is presented using graphical overlay information (i.e., information which overlays the video content presented using PD 204). In one embodiment, the programming change event notification is presented using infrared signals which cause RC 206 to flash, vibrate, and the like.

In accordance with one embodiment of the present invention, IRR 218 is adapted for transmitting signals to RC 206. In one embodiment, IRR 218 is adapted for transmitting notification signals to RC 206 for informing a user of a programming change event. In one such embodiment, IRS 207 is a bidirectional infrared signal adapted for conveying notification signals to RC 206. In one embodiment, IRR 218 transmits notification signals to RC 206 in response to a signal from CNT 214. In this embodiment, RC 206 is adapted for receiving notification signals from IRR 218. The RC 206 processes signals received from IRR 218 for notifying at least one user of a programming change event.

In accordance with this embodiment of the present invention, RC 206 is adapted for notifying at least one user of a programming change event using at least one of a plurality of user notification means. For example, RC 206 may include user notification means including at least one of at least one flashing light (e.g., causing at least one button on RC 206 to flash in response to a notification signal received by RC 206 in response to a detected programming change event), vibration (e.g., causing RC 206 to vibrate one or more times in response to a notification signal received by RC 206 in response to a detected programming change event), and like user notification means, as well as various combinations thereof.

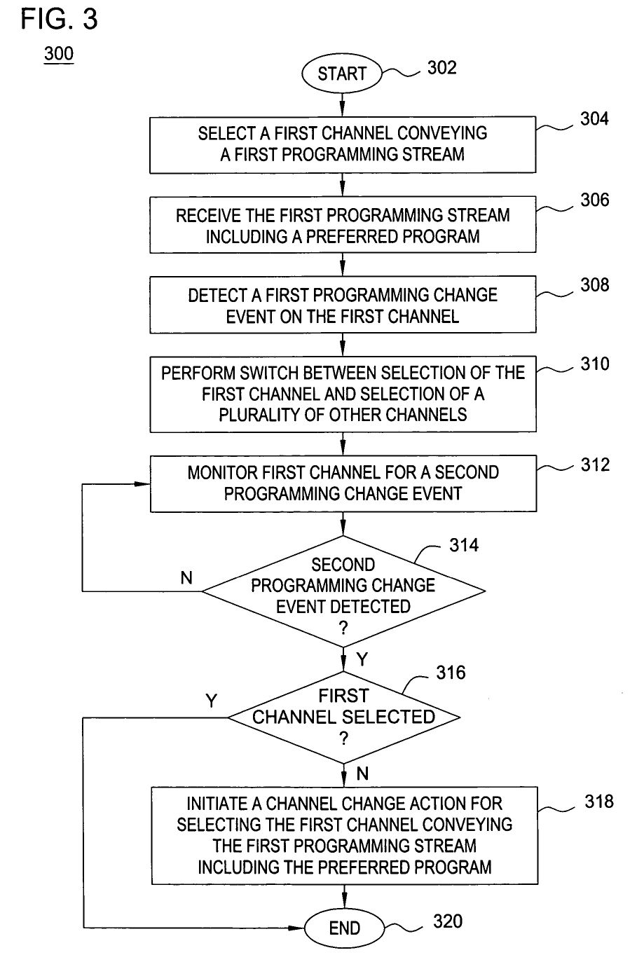

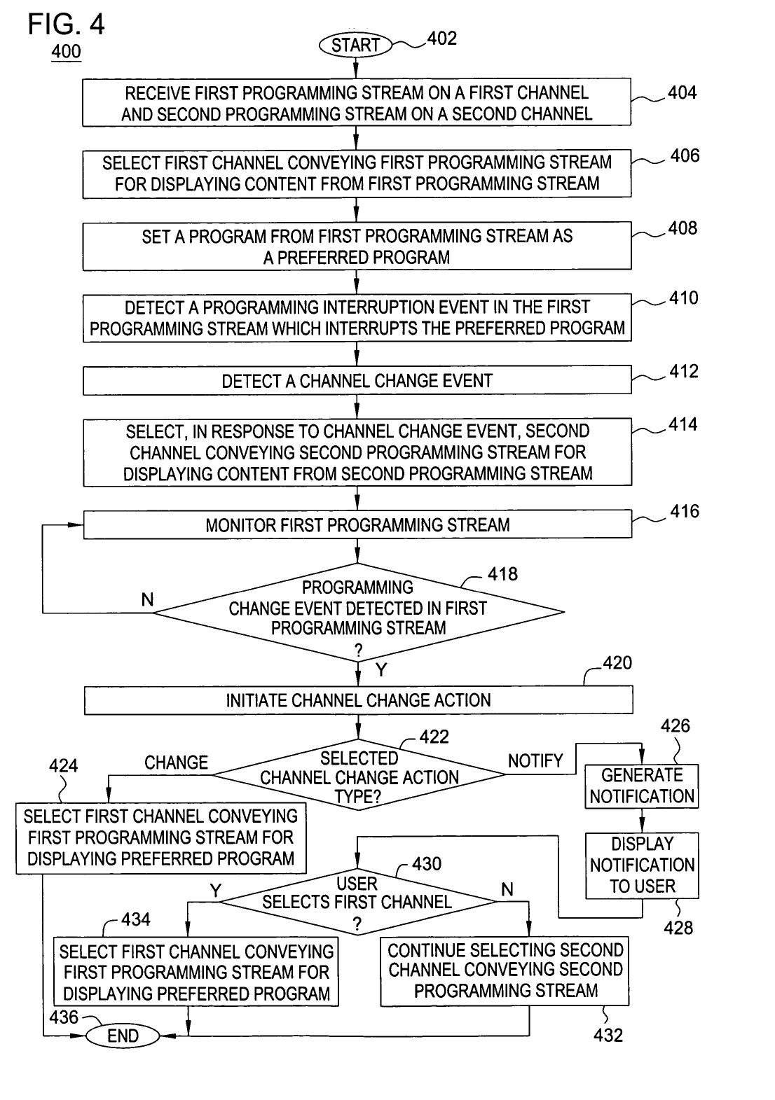

As described herein, programs (illustratively, programs 272) may include the routines and methods executed to implement embodiments of the present invention, and may be implemented as part of an operating system (illustratively, operating system 276) or a specific application, applet, component, program, module, object, or sequence of instructions. In one embodiment, data 274 includes preferred program information. For example, data 274 may include a list of preferred programs which, while selected for display using a display device, invoke the methodologies of the present invention. Within the context of the present invention, programs 272 include programs which, when executed, perform methods according to the present invention, such as described below with respect to FIG. 3 and FIG. 4.

In one embodiment, the present invention (e.g., various modules or processes of the present invention) is stored in (or loaded into) memory (illustratively, MEM 270) and executed by a processor (illustratively, PROC 250) to implement the functions as discussed above. Furthermore, although depicted as a general purpose computer (illustratively, CNT 214) programmed to perform specific programming stream monitoring and selection functions in accordance with various embodiments of the present invention, the present invention can be implemented in hardware as an application specific integrated circuit (ASIC). As such, the process steps described herein are intended to be broadly interpreted as being equivalently performed by software, hardware, or a combination thereof.

FIG. 3 depicts a method according to one embodiment of the present invention. Specifically, method 300 of FIG. 3 comprises a method for initiating a television channel change action adapted for reverting from displaying television content conveyed by a second programming stream associated with a second channel to displaying television content (i.e., a preferred television program) conveyed by a first programming stream associated with a first channel. Although depicted as being performed serially, those skilled in the art will appreciate that at least a portion of the steps of method 300 may be performed contemporaneously, or in a different order than presented in FIG. 3. The method 300 begins at step 302 and proceeds to step 304.

At step 304, a first channel conveying a first programming stream is selected. At step 306, the first programming stream is received. In one embodiment, the first programming stream conveys television content (e.g., television programs, commercials, public service announcements, and the like). The selection of the first channel results in displaying (i.e., using a display device) of the television content conveyed by the first programming stream. In one embodiment, television content conveyed by the first programming stream includes a preferred television program. In one embodiment, selection of the first channel is initiated by a user (e.g., selecting a television channel using a remote control, illustratively, RC 206). For example, a user may select the American Broadcast Corporation (ABC) channel conveying the television program “Lost”, where “Lost” is selected as a preferred program.

At step 308, a first programming change event is detected on the first channel. In one embodiment, the first programming change event is detected automatically (e.g., by CPE 130) by monitoring the first programming stream associated with the first channel. In one embodiment, the first programming change event is detected manually (e.g., by a user associated with CPE 130) by monitoring the television content associated with the first channel. In one embodiment, the first programming change event comprises a start of a programming interruption event. In one such embodiment, the programming interruption event includes commercials, public service announcements, and the like). In continuation of the above example, “Lost” is interrupted by a series of commercial advertisements.

At step 310, a switch between selection of the first channel and selection of a second channel, where the second channel includes one of a plurality of other channels, is performed. The selection of the second channel results in displaying (i.e., using a display device) of the television content conveyed by the second programming stream. In continuation of the above example, the user may select the National Broadcasting Corporation (NBC) channel conveying the television program “The Apprentice: Martha Stewart” (i.e., the user would prefer to watch “The Apprentice: Martha Stewart” on NBC rather than watch commercial advertisements interrupting “Lost” on ABC).

At step 312, the first channel is monitored for a second programming change event. In one embodiment, the first programming stream associated with the first channel is monitored for the second programming change event. In one embodiment, the second programming change event comprises one of the end of a programming interruption event or resumption of the preferred program. In one such embodiment, the programming interruption event includes commercials, public service announcements, and the like). At step 314, a determination is made as to whether the second programming change event is detected. If the second programming change event is not detected, method 300 returns to step 312 for monitoring the first channel for the second programming change event. If the second programming change event is detected, method 300 proceeds to step 316.

In one embodiment, detection of the second programming change event is performed using an audio portion of the first programming stream. For example, in one such embodiment, since the volume of commercials is normally louder than the volume of programs, detection of a decrease in volume in the first programming stream indicates resumption of the preferred program. In one embodiment, detection of the second programming change event is performed using a video portion of the first programming stream. For example, in one such embodiment, since most television channels display an associated television channel logo during television programs, detection of television channel logo in the first programming stream indicates resumption of the preferred program. In continuation of the above example, resumption (after being interrupted by a series of commercial advertisements) of “Lost” is detected.

At step 316, a determination is made as to whether the first channel is selected for displaying the television content conveyed by the first programming stream of the first channel. Since users may select multiple different channels (i.e., “channel surf”) during commercials which interrupt a preferred program, the user may have accurately timed selection of the first channel to coincide with resumption of the preferred program conveyed by the first programming stream of the first channel. If the first channel is selected, method 300 proceeds to step 320 where method 300 ends. If the first channel is not selected, method 300 proceeds to step 318.

In continuation of the above example, a determination is made as to whether the ABC channel is already selected when the commercial interruption (which interrupted “Lost”) ends. If the ABC channel is currently selected for displaying “Lost” to the user when the commercial interruption ends, reversion to the ABC channel for displaying “Lost” is not required (i.e., ABC channel remains the channel selected for display). If the ABC channel is not currently selected for displaying “Lost” to the user when the commercial interruption ends, reversion to the ABC channel for displaying “Lost” is required.

At step 318, a channel change action is initiated for selecting the first channel conveying the first programming stream including the preferred program. The method 300 then proceeds to step 320 where method 300 ends. In one embodiment, a channel change action includes automatically reverting from selecting the second channel conveying the second programming stream to selecting the first channel conveying the first programming stream including the preferred program. In one embodiment, the channel change action includes generating a programming notification adapted for manually reverting from selecting the second channel conveying the second programming stream to selecting the first channel conveying the first programming stream.

As described herein, in one embodiment, the present invention automatically switches television channels in response to a programming change event. The television channel switch includes a change from selecting the second channel conveying the second programming stream to selecting the first channel conveying the first programming stream. In other words, the present invention enables automatic reversion, e.g., at the end of a commercial interruption, to a television channel conveying a preferred program, e.g., when the user has switched to another television channel during a commercial interruption on the television channel carrying the preferred program.

As described herein, in one embodiment, the present invention generates a programming notification in response to a programming change event (e.g., the end of a commercial interruption of a preferred program, the resumption of a preferred program following a commercial interruption, and the like). The programming notification informs a user of the programming change event. The programming notification may be presented using at least one of a display device (illustratively, DD 204) and a remote control (illustratively, RC 206), and the like, as well as various combinations thereof. In one embodiment, the programming notification provides the user a means (e.g., a selectable link displayed by the display device and actuated by a remote control) of manually switching to the television channel conveying the preferred program.

FIG. 4 depicts a method according to one embodiment of the present invention. Specifically, method 400 of FIG. 4 comprises a method for initiating a television channel change action adapted for reverting from displaying television content conveyed by a second programming stream associated with a second channel to displaying television content (i.e., a preferred television program) conveyed by a first programming stream associated with a first channel. Although depicted as being performed serially, those skilled in the art will appreciate that at least a portion of the steps of method 400 may be performed contemporaneously, or in a different order than presented in FIG. 4. The method 400 begins at step 402 and proceeds to step 404.

At step 404, a first programming stream and a second programming stream are received on a first channel and a second channel, respectively. At step 406, the first channel conveying the first programming stream is selected for displaying content from the first programming stream. At step 408, a program from the first programming stream is set as a preferred program. At step 410, a programming interruption event is detected in the first programming stream. The programming interruption event (e.g., commercials, public service announcement, and the like) interrupts the preferred program. At step 412, a channel change event is detected. At step 414, the second channel conveying the second programming stream is selected (in response to the channel change event) for displaying content from the second programming stream.

At step 416, the first programming stream is monitored. At step 418, a determination is made as to whether a programming change event is detected in the first programming stream. If a programming change event is not detected, method 400 returns to step 416 for continuing to monitor the first program stream for the programming change event. If a programming change event is detected, method 400 proceeds to step 420. At step 420, a channel change action is initiated. In one embodiment, a channel change action includes automatically reverting from selecting the second channel conveying the second programming stream to selecting the first channel conveying the first programming stream including the preferred program. In one embodiment, the channel change action includes generating a programming notification adapted for manually reverting from selecting the second channel conveying the second programming stream to selecting the first channel conveying the first programming stream.

At step 422, a selected channel change action type is determined. If the channel change action includes automatically reverting from selecting the second channel conveying the second programming stream to selecting the first channel conveying the first programming stream including the preferred program (illustratively, denoted as CHANGE), method 400 proceeds to step 424. If the channel change action includes generating a programming notification adapted for manually reverting from selecting the second channel conveying the second programming stream to selecting the first channel conveying the first programming stream, (illustratively, denoted as NOTIFY), method 400 proceeds to step 426.

At step 424, the first channel conveying the first programming stream is selected for displaying the preferred program. The method 400 then proceeds to step 436, where method 400 ends. At step 426, a notification is generated. In one embodiment, the notification is adapted for informing a user that the programming interruption event which interrupted the preferred program on the first channel has ended (e.g., the preferred program has resumed following completion of a series of commercial advertisements). At step 428, the notification is presented to the user. In one embodiment, the notification is presented to the user using at least one of a display device, a remote control, and the like, as well as various combinations thereof.

In one embodiment, in which the notification is presented to the user using a display device, the notification may be presented to the user using at least one of an audible presentation function (e.g., sounding an audible indicator) and a visual presentation function (e.g., displaying a message in a portion of the display, displaying a message using a portion of the program guide display function, invoking a picture-in-picture (PIP) function to display the preferred program in a PIP window, and the like), and the like, as well as various combinations thereof. In one embodiment, in which the notification is presented to the user using a remote control device, the notification may be presented to the user using at least one of a remote control lighting function (e.g., flashing at least one light associated with a light or button on the remote control), a remote control vibration function (e.g., causing the remote control to vibrate) and the like, as well as various combinations thereof.

At step 430, a determination is made as to whether the user selects the first channel conveying the first programming stream including the preferred program. If the user does not select the first channel conveying the first programming stream, method 400 proceeds to step 432. At step 432, the second channel conveying the second programming stream continues to be selected (i.e., user opts not to return to the first channel to view the preferred program following the end of the interruption of the preferred program). If the user does select the first channel conveying the first programming stream, method 400 proceeds to step 434. At step 434, the first channel conveying the first programming stream is selected for displaying the preferred program (i.e., user opts to return to the first channel to continue viewing the preferred program following the end of the interruption of the preferred program). The method 400 then proceeds to step 436, where method 400 ends.

Although depicted and described with respect to switching between two television channels (i.e., monitoring a programming stream associated with one channel while another programming stream associated with another channel is select for display), the present invention may be used for switching between more than two television channels. In other words, in one embodiment of the present invention, a plurality of television channels conveying programming streams including a respective plurality of preferred programs may be monitored while one or more other television channels are selected for displaying other television programs. For example, programming streams conveying “Lost” (ABC channel) and “MythBusters” (Discovery Channel) may be monitored while programming streams conveying “The Apprentice: Martha Stewart” (NBC channel) and “Criminal Minds” (CBS channel) are simultaneously displayed using PIP functionality.

Although described with respect to specific programming change event detection means and methods (including detection of the start of programming interruption events, the end of programming interruption event, the start of programming resumption events, and the like) and channel change action initiation means and methods (including initiating automatic reversion to a channel associated with a programming stream conveying a preferred program, initiating a notification message adapted for providing a user a means of initiating manual reversion to a channel associated with a programming stream conveying a preferred program, and the like), various other programming change event detection means and methods and channel change action initiation means and methods may be used in accordance with different embodiments of the present invention.

Although various embodiments which incorporate the teachings of the present invention have been shown and described in detail herein, those skilled in the art can readily devise many other varied embodiments that still incorporate these teachings.

What is claimed is:

1. A method, comprising:
receiving a first programming stream and a second programming stream from a plurality of television programming streams;
selecting the first programming stream for displaying first programming conveyed by the first programming steam;
monitoring the second programming stream while displaying the first programming; and
in response to a detecting a first programming change event in the second programming stream, initiating a first channel change action adapted for selecting the second programming stream for displaying second programming conveyed by the second programming steam.

2. The method of claim 1, wherein the programming change event comprises a change from a first programming type to a second programming type.

3. The method of claim 1, further comprising:
selecting a third programming stream from the plurality of television programming streams, the third programming stream replacing selection of the first programming stream, the third programming stream selected for displaying third programming conveyed by the third programming stream; and
monitoring the second programming stream while displaying the third programming.

4. The method of claim 1, wherein receiving the first programming stream and the second programming stream comprises:
selecting the first programming stream from a plurality of television programming streams; and
selecting the second programming stream from the plurality of television programming streams.

5. The method of claim 1, wherein initiating the channel change action comprises:
switching from displaying the first programming to displaying the second programming.

6. The method of claim 1, further comprising:
monitoring the second programming stream while displaying the second programming conveyed by the second programming stream; and
in response to detecting a second programming change event in the second programming stream, initiating a second channel change action adapted for selecting the first programming stream for displaying first programming conveyed by the first programming steam.

7. The method of claim 6, wherein the second programming change event comprises a change from the second programming type to the first programming type.

8. The method of claim 1, wherein initiating the first channel change action comprises:
generating a signal adapted for notifying a user of the programming change event.

9. The method of claim 8, further comprising:
propagating the signal to at least one user interface, wherein the at least one user interface comprises at least one of at least one display device or at least one remove control device; and
presenting a notification to the user in response to the signal.

10. A method, comprising:
detecting a programming change event on a first channel conveying a programming stream including a preferred program;
in response to the programming change event, determining whether the first channel is selected for displaying the preferred program; and
in response to a determination that the first channel is not selected, initiating a channel change action adapted for selecting the first channel for displaying the preferred program.

11. The method of claim 10, wherein the programming change event comprises a change from a first programming type to a second programming type.

12. The method of claim 10, wherein the programming change event comprises one of an end of a program interruption event or a resumption of the preferred program.

13. The method of claim 12, wherein the program interruption event comprises at least one of a commercial or a public service announcement.

14. The method of claim 10, wherein detecting the programming change event comprises:
monitoring the first channel for a programming change indicator while a second channel conveying another program is selected for displaying the other program; and
detecting the programming change event in response to detecting the programming change indicator.

15. The method of claim 14, wherein the programming change indicator comprises one of a change in an audio portion of the preferred program conveyed by the first channel or a change in a video portion of the preferred program conveyed by the first channel.

16. The method of claim 10, wherein initiating the channel change action comprises:
switching from selecting the second channel for displaying the other program to selecting the first channel for displaying the preferred program.

17. The method of claim 10, wherein initiating the channel change action comprises:
generating a signal adapted for notifying a user of the programming change event.

18. The method of claim 17, further comprising:
propagating the signal to at least one user interface, wherein the at least one user interface comprises at least one of at least one display device or at least one remove control device; and
presenting a notification to the user in response to the signal.

19. An apparatus, comprising:
a first module for processing a first programming stream associated with a first channel;
a second module for processing a second programming stream associated with a second channel;
a controller coupled to the first module and the second module, the controller configurable for:
selecting the first programming stream associated with the first module for displaying first programming conveyed by the first programming stream;
monitoring the second programming stream associated with the second module for detecting a first programming change event associated with second programming conveyed by the second programming stream; and
in response to detecting the first programming change event, selecting the second programming stream associated with the second module for displaying second programming conveyed by the second programming stream.

20. The apparatus of claim 19, wherein the controller is further configurable for:
in response to detecting the first programming change event, monitoring the second programming stream for detecting a second programming change event associated with the second programming conveyed by the second programming stream; and
in response to detecting the second programming change event, selecting the first programming stream associated with the first module for displaying first programming conveyed by the first programming stream.
